(19) United States
(12) Patent Application Publication
(10) Pub. No.: US 2006/0039265 A1
(43) Pub. Date: Feb. 23, 2006

(54) Pickup module with coating layer

(75) Inventor: Yen-Chih Lee, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/206,755

(22) Filed: Aug. 19, 2005

(30) Foreign Application Priority Data
Aug. 20, 2004 (TW) 93125114

(51) Int. Cl. G11B 7/00

(52) U.S. Cl. 369/112.01; 369/110.01

(57) ABSTRACT

A pickup module comprises a plurality of optical components along an optical path, wherein at least two of the optical components are provided with coating layers to change a polarization of a light beam and collectively circularly polarize the light beam. The circularly-polarized beam is projected on an optical storage medium and converted to a signal beam received by an optical detector. A quarter wavelength plate (QWP) or the other phase retarded plate for required purpose (½λ, ¼λ, ⅛λ . . . ) is not included in the optical component set.

### BACKGROUND

The invention relates to an optical recorder and, in particular, to an optical pickup module.

Information access by an optical pickup module is accomplished by focusing a laser beam on a surface of a storage medium(disc) and converting the reflected beam to an electronic signal via a photo detector. Circularly polarized laser beams incident on the surface of the disc provide improved signal accuracy, and are thus required in optical pickup module.

FIG. 1A shows a conventional pickup module, comprising a first laser diode 101 for DVD, a second laser diode 103 for CD, first polarized beam splitter 105 and second polarized beam splitter 107, a folding mirror 109, a quarter wavelength plate 111, and a photo detector 113. The first laser diode 101 and second laser diode 103 generate laser beams. The laser beams from first laser diode 101 and second laser diode 103 are linearly polarized, i.e., having no phase difference between orthogonal components S-wave and P-wave. The first polarized beam splitter 105 and the second polarized beam splitter 107 transmit or reflect different components (S-wave and P-wave). The folding mirror 109 reflects a light beam and changes the propagation direction of the light beam. The quarter wavelength plate 111 changes the polarization of the light beam and phase difference between the S-wave and P-wave. When the phase difference between the S-wave and P-wave reaches 90 or 270° (−90°), the light beam is converted to a circularly polarized light for optimum signal accuracy. The photo detector 113 receives the light beam reflected from a surface of a disc.

For a CD system, operation thereof is almost the same as that of a DVD system. In order to explain the invention, we use the CD system to illustrate. After the laser diode 103 for CD emits a laser beam, orthogonal S-wave and P-wave components are generated, having initial intensities of respectively I_{S1} and I_{P1}. If an initial phase difference is δ_{S-P}=0°, as shown in FIG. 1B, when the CD light beam enters the second polarized beam splitter 107, the reflectivity of the S-wave and the P-wave are respectively 0% and 90%, as shown by solid arrows in FIG. 1C. In FIG. 1C, the dashed arrow represents the orthogonal components of the light beam before the CD light beam passes the second polarized beam splitter 107, and the dotted arrow the orthogonal components of the CD light beam after the CD light beam passes the second polarized beam splitter 107. When the light beam reaches the folding mirror 109, reflectivity of the S-wave and the P-wave are respectively 70% and 20%, as shown by solid arrows in FIG. 1D. Optical characteristics of the second polarized beam splitter 107 and the folding mirror 109 are shown in Table I.

TABLE I

| | the second | |
|---|---|---|
| | polarized beam | Folding |
| reflectivity | splitter 107 | mirror109 |
| S-wave | 0% | 70% |
| reflectivity | | |
| P-wave | 90% | 20% |
| reflectivity | | |

Thus, intensity I_{S} of the S-wave(reflected by the second polarized beam splitter 107) becomes 0 and intensity I_{P} of the P-wave which passing the second polarized beam splitter 107 equals I_{P1}×90%, i.e., 0.9I_{P1}. Thereafter, the S-wave is reflected by the folding mirror 109 and intensity I_{S} of the S-wave equals 0×70%, i.e., 0. Intensity I_{P} of the P-wave reflected by the folding mirror 109 equals 0.9I_{P1}×20%, i.e., 0.18I_{P1}. The CD light beam is converted to a circularly polarized state by a quarter wavelength plate 111 before reaching a disc, as shown in FIG. 1E. As a result, although the light beam is eventually converted to a circularly polarized state, energy stored in the S-wave component is never used.

### SUMMARY

An embodiment of a pickup module comprises a plurality of optical components along an optical path, wherein at least two of the optical components are provided with coating layers with phase design to change polarization of a light beam and collectively circularly polarize the light beam. The circularly polarized beam is projected onto an optical storage medium and converted to a signal beam received by an optical detector. A quarter wavelength plate(QWP) is not included in the optical component set.

An embodiment of a method of fabricating an optical component set comprising a plurality of optical components, excluding a quarter wavelength plate, comprises coating a first coating layer on a first polarized beam splitter, coating a second coating layer on a second polarized beam splitter, and coating an nth coating layer on an nth optical component. The first, second and nth coating layers collectively convert a non-circularly polarized light beam to a circularly polarized light beam projected on an optical storage medium and converted to a signal beam received by an optical detector.

The pickup module according to the embodiment of the invention requires no quarter wavelength plate or the other phase retarded plate for the required purpose(½λ, ¼λ, ⅛λ . . . ), thus reducing cost thereof and avoiding problems resulting from poor quality or poor assembly thereof. In addition, phase difference is induced by combinations of different optical components with coating layers. As a result, coating layers on different optical components change polarization of a light beam such that a better transmittance or reflectivity is optimized and signal intensity improved.

### BRIEF DESCRIPTION OF THE DRAWINGS

FIGS. 1A˜1E are schematic diagrams illustrating optical components of a conventional pickup module and characteristics thereof.

FIGS. 2A˜2E are schematic diagrams illustrating optical components of a pickup module according to an embodiment of the invention and characteristics thereof.

FIGS. 3A˜3D show curves of phase difference generated by the optical components versus wavelength of a light beam.

FIG. 4 is a schematic diagram illustrating optical design of a pickup module according to an embodiment of the invention.

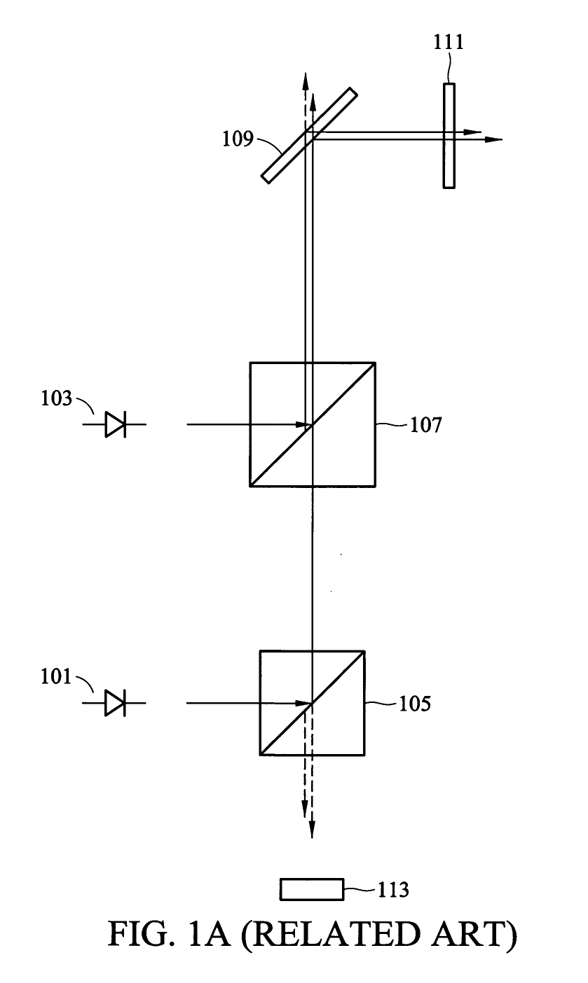

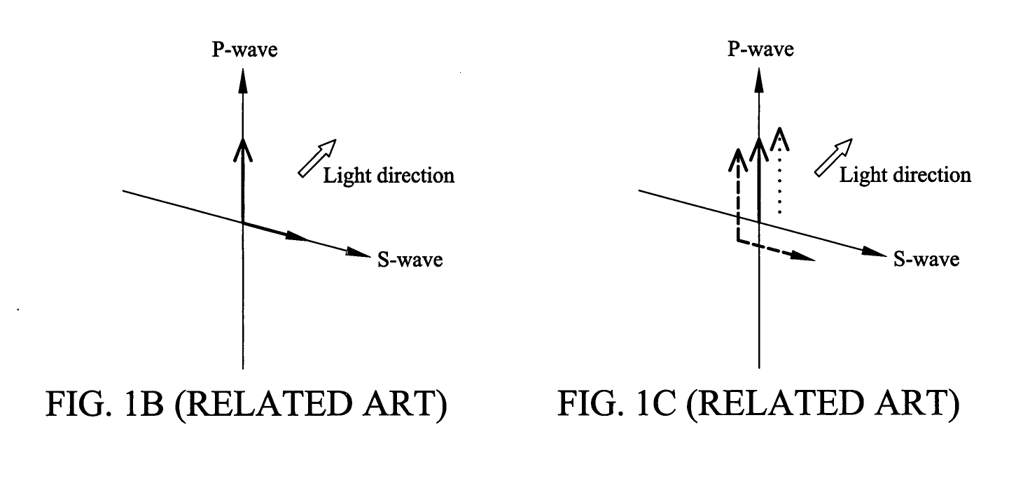

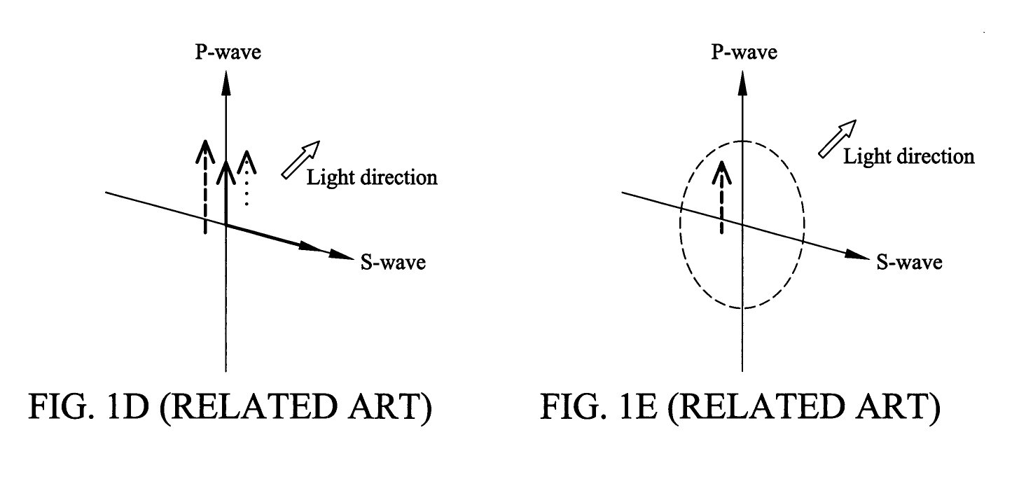

### DETAILED DESCRIPTION

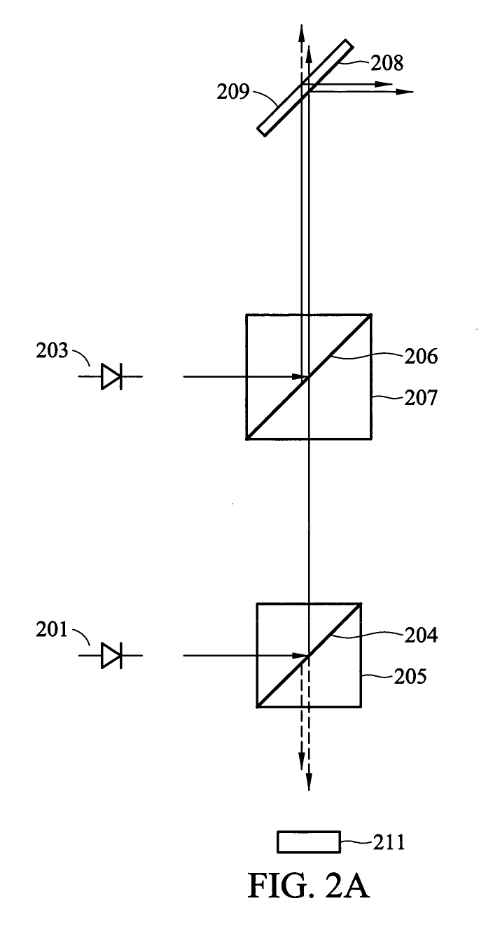

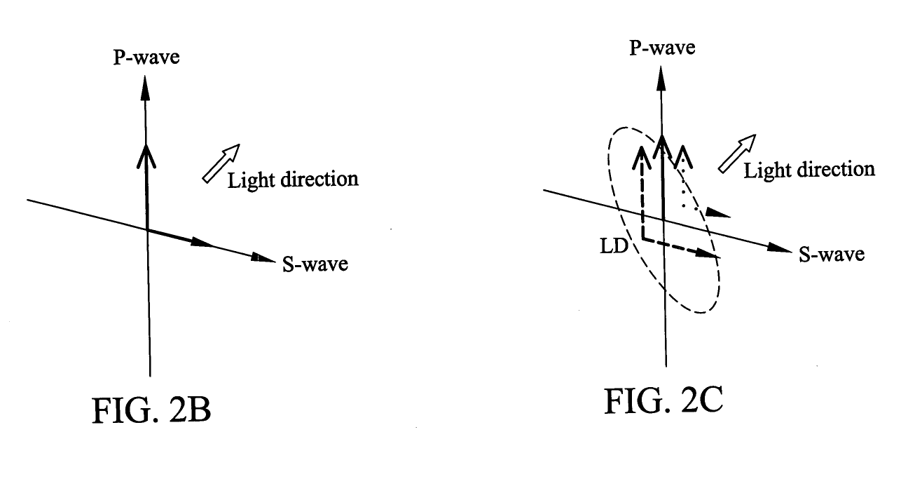

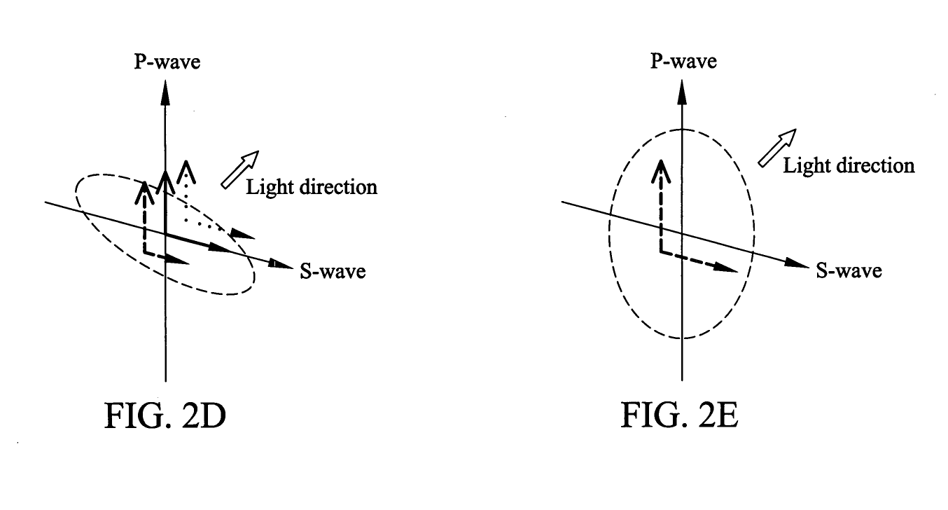

A CD system is taken for example. FIG. 2A is a schematic diagram of a pickup module according to an embodiment of the invention. The pickup module comprises a first laser diode 201 for DVD, a second laser diode 203 for CD, the first polarized beam splitter 205 with a reflective coating layer 204, the second polarized beam splitter 207 with a reflective coating layer 206, a folding mirror 209 with a reflective coating layer 208, and a photo detector 211. The first laser diode 201 and second laser diode 203 generate laser beams for DVD and CD. Referring to FIG. 2A, after the laser diode 203 for CD emits a CD laser beam, orthogonal S-wave and P-wave components are generated, having initial intensities of respectively I_{S1} and I_{P1}. If an initial phase difference is δ_{S-P}=0°, as shown in FIG. 2B, when the light beam enter the second polarized beam splitter 207 with the coating layer 206, the reflectivity of the S-wave and the P-wave are respectively 0% and 90%, as shown-by solid arrows in FIG. 2C. When the light beam enters the folding mirror 209 with the coating layer 208, Reflectivity of the S-wave and the P-wave are respectively 70% and 20%, as shown by solid-arrows in FIG. 2D. In the embodiment of the invention, coating layers of 206 and 208 respectively generate phase differences of 70° and 200°, as shown by dashed ellipses in FIGS. 2C and 2D. Optical characteristics of the second polarized beam splitter 207 and the folding mirror 209 are shown in Table II.

TABLE II

| | The second | |
|---|---|---|
| | polarized | |
| | beam | Folding |
| | splitter 206 | mirror 208 |
| | with coating | with coating |
| reflectivity | layer 207 | layer 209 |
| S-wave reflectivity | 0% | 70% |
| P-wave reflectivity | 90% | 20% |
| Phase difference δ_{S-P} | 70° | 200° |

Thus, when CD laser beam enters the second polarized beam splitter 207 and the coating layer 206, the coating layer 206 redistributes energy of the light beam and generates a phase difference of 700 between the S-wave and the P-wave. As a result, the CD laser beam is elliptically polarized and a long axis thereof modified to the proximity of the P-wave due to higher reflectivity of the P-wave for coating design. For example, if the phase difference δ_{S-P} generated by coating layer 206 on the second polarized beam splitter 207 equals 70°, intensities I_{S} and I_{P} respectively equal 0.15I_{S1} and 0.85I_{P1} after the CD light beam passes through the second polarized beam splitter 207 with the coating layer 206, generating phase difference. If there is no coating layer with phase shift design, no S-wave component energy is retained after the light beam passes the optical component 207.

Subsequently, the same principle can be utilized such that the folding mirror 209 with coating layer 208 redistributes and focuses most energy to the P-wave component. In the absence off coating layer 208 with phase-shift design, since no S-wave component energy is retained after the light beam passes through the second polarized beam splitter 207, the energy in the original S-wave component is never used. For example, if the phase difference δ_{S-P} of the second polarized beam splitter 207 with the coating layer 206 is 70°, the intensities I_{S} and I_{P} respectively equal 0.15I_{S1} and 0.85I_{P1} after the CD light beam passes the second polarized beam splitter 207 with coating layer 206 for CD system, generating a phase difference. The coating layer 208 on the folding mirror 209 generates a phase difference δ_{S-P} of 200 degrees, with most CD light beam energy focused on the P-wave component. As a result, the intensities I_{S} and I_{P} respectively equal 0.13I_{S1} and 0.10I_{P1} after the CD light beam passes the folding mirror 209 with the coating layer 208, generating a phase difference. Intensities I_{S1} and I_{P1} of the S-wave and P-wave components of the original light beam are equivalent. Thus, the total energy of the light beam through the pickup module according to an embodiment of the invention is higher than in a conventional configuration. In addition, the optical components generates a total phase difference of δ_{S-P}=70°+200°=270° or −90°, as shown in FIG. 2E. As a result, a circularly polarized state is obtained.

The same principle is also used for DVD system. The folding mirror 209 reflects a DVD light beam and changes propagation direction thereof. The coating layers 204, 206, and 208 on the first polarized beam splitter 205 and second polarized beam splitter 207 and the folding mirror 209 change polarization of the DVD light beam and phase difference between the S-wave and P-wave. When the phase difference between the S-wave-and P-wave reaches 90° or 270° (−90°), the light beam is converted to a circularly polarized light. The photo detector 211 receives the DVD light beam reflected from a surface of a disc.

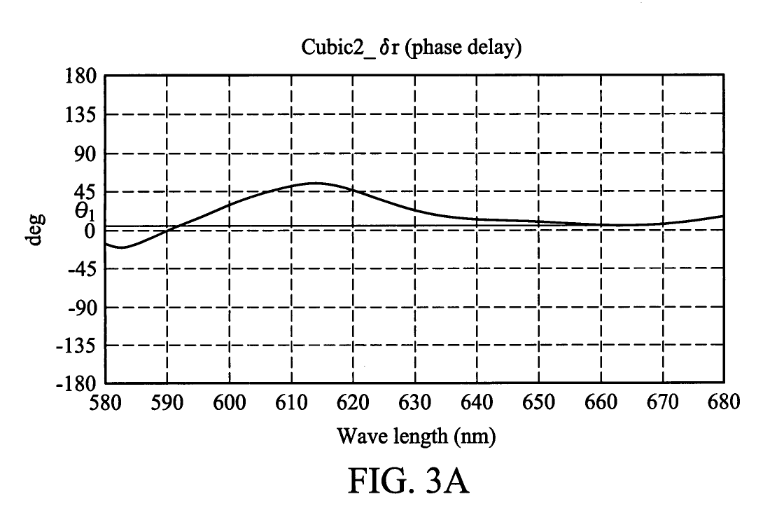

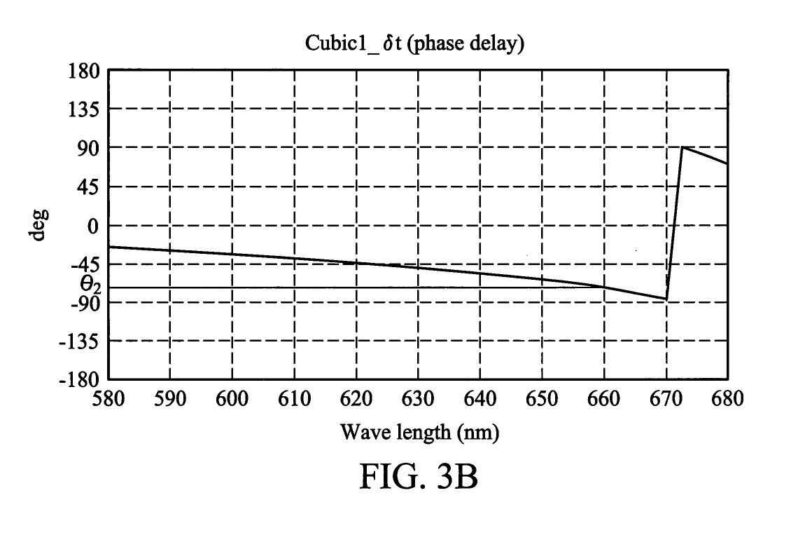

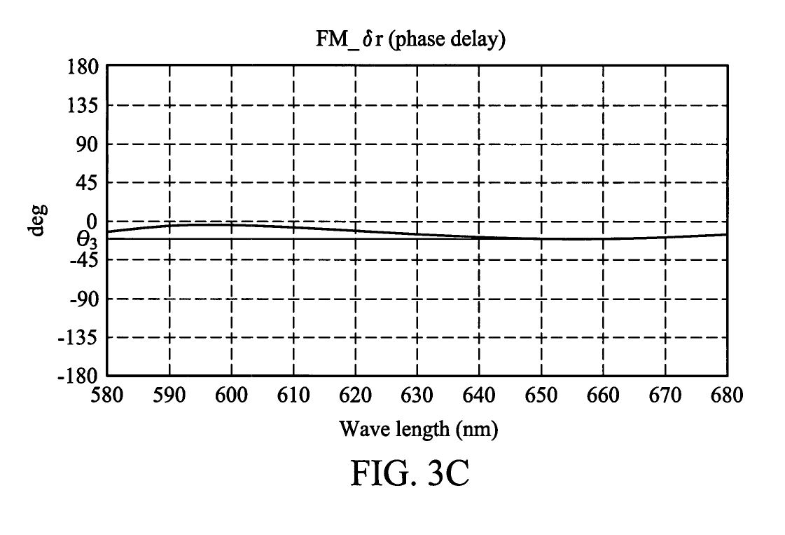

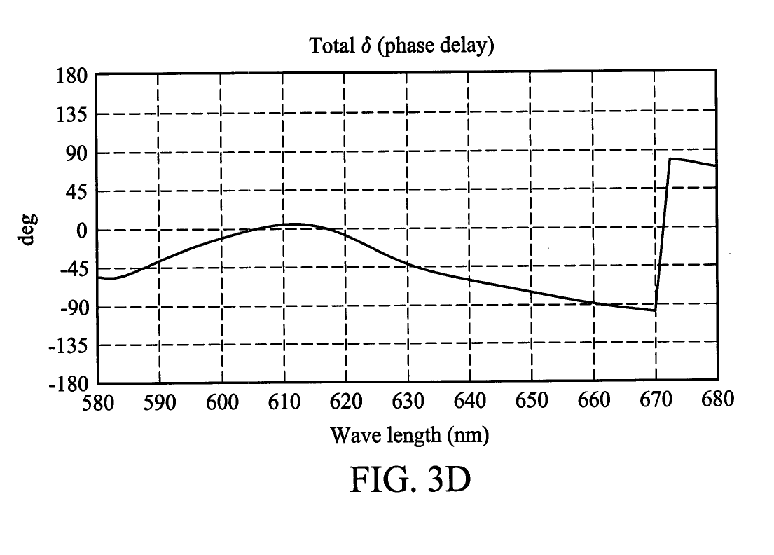

The wavelength of a laser diode 201 for DVD is typically 660 nm. The coating layers 204, 206, and 208 on the first polarized beam splitter 205 the second polarized beam splitter 207 and the folding mirror 209 can provide phase difference with wavelength as shown in FIGS. 3A, 3B and 3C. Thus, when the DVD laser beam passes through the first polarized beam splitter 205 with the coating layer 204 and the second polarized beam splitter 207 with the coating layer 206, and the folding mirror 209 with the coating layer 208, the total phase difference is as shown by the curve in FIG. 3D. When the wavelength of the DVD laser beam is 660 nm, the coating layers 204, 206, and 208 respectively generates phase differences of θ₁, θ₂, and θ₃ between the S-wave and P-wave such that θ₁, θ₂, and θ₃ are:
θ₁+θ₂+θ₃=90° or 270° (1)

Accordingly, the pickup module converts light to a circularly polarized light beam. The effect thereof is the same as that of a quarter wavelength plate. As a result, no quarter wavelength plate is needed. Those skilled in the art can add or remove optical components in the pickup module according to needs. Optical components commonly used in the pickup module can be a laser diode, a beam splitter, a cubic, a grating, a folding mirror, a polarizer, and a collimator. The optical components respectively generate a phase difference of θ₁, θ₂, . . . , and collectively generate a total phase difference of ±90° to obtain a circularly polarized light beam. In summary, the principle is used to take both the phase difference and efficiency into consideration by coating design to reach the better efficiency and phase shift.

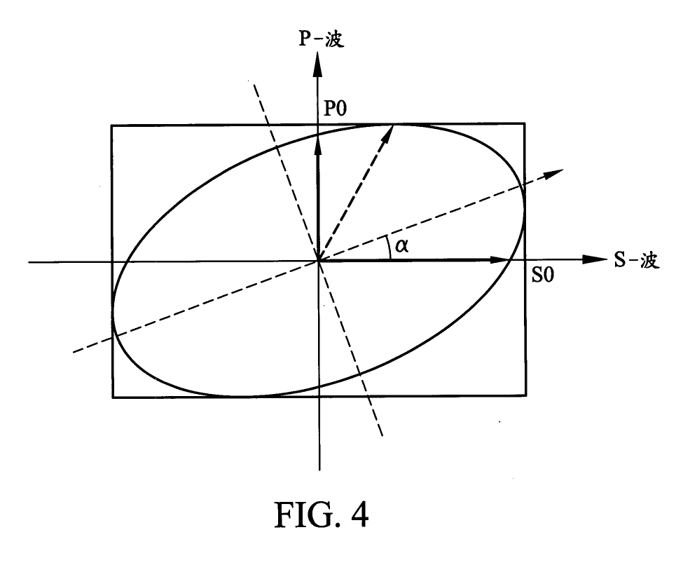

In addition, the invention converts a light beam to a state with higher transmissive or reflective efficiency by generating phase difference. In other words, selection of material, number of coating layers and thicknesses thereof are made according to the required phase difference and reflectivity/transmittance. During design of the optical components, as shown in FIG. 4, a formula as follows can be used.
Tan 2α=2I_{S0}I_{P0} cos θ_{SP}/I_{S0}²−I_{P0}² (2)

I_{S0} and I_{P0} respectively represent reflectivity or transmittance of the optical components with coating layers generating a phase difference. θ_{SP} represents the phase difference between the S-wave and P-wave components, generated by the optical components with coating layers. The angle a represents an angle between a long axis of an elliptically polarized light and an S-wave axis.

The optical component set according to the embodiment of the invention does not require a quarter wavelength plate or the other phase retarded plate for required purpose (½λ, ¼λ, ⅛λ . . . ), reducing cost thereof and avoiding problems resulting from poor quality or poor assembly thereof. In addition, phase difference is induced by combinations of different optical components with coating layers. As a result, coating layers on different optical components change polarization of a light beam such that transmittance or reflectivity is optimized, and signal intensity improved.

While the invention has been described by way of example and in terms of preferred embodiment, it is to be understood that the invention is not limited thereto. To the contrary, it is intended to cover various modifications and the advantages would be apparent to those skilled in the art. Therefore, the scope of the appended claims should be accorded the broadest interpretation so as to encompass all such modifications.

What is claimed is:

1. A pickup module, comprising:
a plurality of optical components along an optical path;
wherein at least two of the optical components are provided with coating layers changing a polarization of a light beam and collectively generating a circularly polarized beam projected on an optical storage medium and converted to a signal beam received by an optical detector, and a quarter wavelength plate is excluded from the optical component set.

2. The pickup module as claimed in claim 1, wherein at least one of the optical components is a laser beam generator.

3. The pickup module as claimed in claim 2, wherein the laser beam generator is a semiconductor laser.

4. The pickup module as claimed in claim 1, wherein at least one of the optical components is a polarized beam splitter.

5. The pickup module as claimed in claim 1, wherein at least one of the optical components is a folding mirror.

6. The pickup module as claimed in claim 1, wherein at least one of the optical components is a collimator.

7. The pickup module as claimed in claim 1, wherein the coating layers can further change the polarization of the light beam such that the signal beam received by the optical detector has a maximum intensity.

8. A method of fabricating a pickup module comprising a plurality of optical components, excluding a quarter wavelength plate, comprising:
coating a first coating layer on a first optical component of the optical component set;
coating a second coating layer on a second optical component of the optical component set; and
coating an nth coating layer on an nth optical component;
wherein the first, second and nth coating layers collectively convert a non-circularly polarized light beam to a circularly polarized light beam projected on an optical storage medium and converted to a signal beam received by an optical detector.

9. The method as claimed in claim 8, wherein at least one of the optical components is a laser beam generator.

10. The method as claimed in claim 9, wherein the laser beam generator is a semiconductor laser.

11. The method as claimed in claim 8, wherein at least one of the optical components is a polarized beam splitter.

12. The method as claimed in claim 8, wherein at least one of the optical components is a folding mirror.

13. The method as claimed in claim 8, wherein at least one of the optical components is a collimator.

14. The method as claimed in claim 8, wherein the coating layers can further change the polarization of the light beam such that the signal beam received by the optical detector has a maximum intensity.
